(19) United States
(12) Patent Application Publication
(10) Pub. No.: US 2024/0168716 A1
(43) Pub. Date: May 23, 2024

(54) IMAGE PROCESSING DEVICE INCLUDING CALCULATION PROCESSING DEVICE AND CALCULATING METHOD OF THE IMAGE PROCESSING DEVICE

(71) Applicant: SK hynix Inc., Icheon-si Gyeonggi-do (KR)

(72) Inventors: Kazuhiro Yahata, Icheon-si Gyeonggi-do (KR); Satoru Saito, Icheon-si Gyeonggi-do (KR)

(73) Assignee: SK hynix Inc., Icheon-si Gyeonggi-do (KR)

(21) Appl. No.: 18/301,073

(22) Filed: Apr. 14, 2023

(30) Foreign Application Priority Data
Nov. 23, 2022 (KR) 10-2022-0158518

(51) Int. Cl. G06F 7/535; G06F 7/02; G06F 7/499

(52) U.S. Cl. CPC G06F 7/535; G06F 7/02; G06F 7/4991

(57) ABSTRACT

An image processing device including a calculation processing device is provided. The calculation processing device includes: a preprocessor for extracting an effective divisor, an effective dividend, and an overflow bit for correcting a calculation result from a divisor and a dividend, based on a maximum bit number of the calculation result; a calculator for outputting a division value as a result obtained by performing a comparison calculation operation by a number of times, which is determined according to the maximum bit number, based on the effective divisor and the effective dividend; and a postprocessor for correcting the division value, based on the overflow bit.

### CROSS-REFERENCE TO RELATED APPLICATION

The present application claims priority under 35 U.S.C. § 119(a) to Korean patent application number 10-2022-0158518 filed on Nov. 23, 2022, in the Korean Intellectual Property Office, the entire disclosure of which is incorporated by reference herein.

### BACKGROUND

### 1. Technical Field

The present disclosure generally relates to an image processing device, and more particularly, to an image processing device and a calculating method of the image processing device.

### 2. Related Art

An image processing device may improve the quality of an image by performing an image processing operation. The image processing device may perform the image processing operation by calculating pixel values. The calculation amount of the image processing device is increasing due to the appearance of high-quality image sensors.

There may occur a case where the bit number of an output signal of the image processing device is limited. In order to prevent overload and resource waste of the image processing device, it is necessary to decrease the calculation amount of the image processing device. When the calculation amount of the image processing device is decreased, the image processing speed of the image processing device can be increased.

### SUMMARY

In accordance with an embodiment of the present disclosure, there is provided a calculation processing device including: a preprocessor configured to extract an effective divisor, an effective dividend, and an overflow bit for correcting a division value from a divisor and a dividend, based on a maximum bit number of the division value; a calculator configured to output the division value as a result obtained by performing a comparison calculation operation by a number of times, which is determined according to the maximum bit number, based on the effective divisor and the effective dividend; and a postprocessor configured to correct the division value, based on the overflow bit.

In accordance with another embodiment of the present disclosure, there is provided an image processing device including: a data receiver configured to receive pixel values from an external device; and a calculation processing device configured to perform a calculation operation with a maximum bit number of an output being limited to y, based on the pixel values, wherein the calculation processing device includes: a preprocessor configured to extract an effective divisor, an effective dividend, and an overflow bit for correcting the output from a divisor and a dividend, based on the maximum bit number; a calculator configured to output a division value obtained by performing a comparison calculation operation (y+1) times, based on the effective divisor and the effective dividend; and a postprocessor configured to correct the division value, based on the overflow bit. The y is a natural number greater than zero.

In accordance with still another embodiment of the present disclosure, there is provided a calculation processing method including: receiving information on a divisor, a dividend, and a maximum bit number y of a division value; extracting an effective divisor, an effective dividend, and an overflow bit for correcting the division value from the divisor and the dividend, based on the maximum bit number y; generating the division value obtained by performing a comparison calculation operation (y+1) times, based on the effective divisor and the effective dividend; and correcting the division value, based on the overflow bit. The y is a natural number greater than zero.

### BRIEF DESCRIPTION OF THE DRAWINGS

Examples of embodiments will now be described more fully hereinafter with reference to the accompanying drawings; however, they may be embodied in different forms and should not be construed as limited to the embodiments set forth herein.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a diagram illustrating a calculation processing device in accordance with an embodiment of the present disclosure.

FIG. 2 is a diagram illustrating a method of generating an effective divisor in accordance with an embodiment of the present disclosure.

FIG. 3 is a diagram illustrating a method of generating an effective divisor, an effective dividend, and an overflow bit in accordance with an embodiment of the present disclosure.

FIG. 4 is a diagram illustrating a method of generating the effective divisor, the effective dividend, and the overflow bit in accordance with another embodiment of the present disclosure.

FIG. 5 is a diagram illustrating a method of generating the effective divisor, the effective dividend, and the overflow bit in accordance with still another embodiment of the present disclosure.

FIG. 6 is a diagram illustrating a fixed value generated according to a value of a divisor in accordance with an embodiment of the present disclosure.

FIG. 7 is a diagram illustrating a method of calculating a division value by performing a comparison calculation operation in accordance with an embodiment of the present disclosure.

FIG. 8 is a diagram illustrating a method of correcting a division value, based on an overflow bit in accordance with an embodiment of the present disclosure.

FIG. 9 is a flowchart illustrating a calculation processing method in which a maximum bit number of an output signal is determined in accordance with an embodiment of the present disclosure.

FIG. 10 is a diagram illustrating an electronic device including a calculation processing device in accordance with an embodiment of the present disclosure.

### DETAILED DESCRIPTION

The specific structural or functional description disclosed herein is merely illustrative for the purpose of describing embodiments according to the concept of the present disclosure. The embodiments according to the concept of the present disclosure can be implemented in various forms, and cannot be construed as limited to the embodiments set forth herein.

Hereinafter, embodiments of the present disclosure will be described in detail with reference to the accompanying drawings in order for those skilled in the art to be able to readily implement the technical spirit of the present disclosure.

Embodiments provide an image processing device for limiting a performance number of a comparison calculation operation such that the comparison calculation operation is performed by a number corresponding to a maximum bit number of an output signal, and a calculating method of the image processing device.

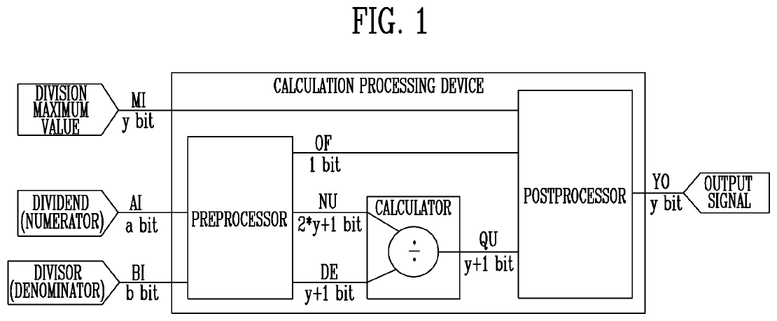

FIG. 1 is a diagram illustrating a calculation processing device in accordance with an embodiment of the present disclosure.

Referring to FIG. 1, a bit number of an output signal YO of the calculation processing device may be limited. The calculation processing device may receive a division maximum value MI as information associated with the bit number of the output signal YO. The bit number of the output signal YO of the calculation processing device may be determined regardless of a dividend AI and a divisor BI.

The calculation processing device may include a preprocessor, a calculator, and a postprocessor. The calculation processing device may receive information on the division maximum value MI, the dividend AI, and the divisor BI from the outside. In FIG. 1, it may be expressed that the division maximum value MI is a group of bits having ‘y’ number of bits y bits, the dividend AI is a group of bits having ‘a’ number of bits a bits, and the divisor BI is a group of bits having ‘b’ number of bits b bits.

The preprocessor may extract an effective divisor DE, an effective dividend NU, and an overflow OF bit for correcting a calculation result from the divisor BI and the dividend AI, based on the y bits which is a maximum bit number of the division maximum value MI. Corresponding to that a maximum bit number of the division maximum value MI is the y bits, it may be expressed that the effective divisor DE is y+1 bits, the effective dividend NU is 2y+1 bits, and an overflow OF is 1 bit. In an embodiment of the present disclosure, the y bits as the maximum bit number of the division maximum value MI may be predetermined regardless of the divisor BI and the dividend AI. The word “predetermined” as used herein with respect to a parameter, such as a predetermined y bits and predetermined fixed values, means that a value for the parameter is determined prior to the parameter being used in a process or algorithm. For some embodiments, the value for the parameter is determined before the process or algorithm begins. In other embodiments, the value for the parameter is determined during the process or algorithm but before the parameter is used in the process or algorithm.

The preprocessor may detect a first position as a position of a most significant bit having a first logic value in the divisor BI. In an embodiment of the present disclosure, the first logic value may mean 1. The preprocessor may generate the effective divisor DE including the y+1 bits in a lower bit direction from the first position.

The preprocessor may perform first padding of filling a residual portion of the effective divisor DE with a second logic value, corresponding to that the number of remaining bits in the lower bit direction from the first position of the divisor BI is smaller than y+1. In an embodiment of the present disclosure, the second logic value may mean 0, and the first padding may mean zero padding.

The preprocessor may detect a second position as a position of the dividend AI corresponding to a position of a least significant position. The preprocessor may generate the effective dividend NU including y*2+1 bits in an upper bit direction from the second position. The preprocessor may perform second padding of filling lower bits of the effective dividend NU with the second logic value by the same number as the first padding.

The preprocessor may detect a correction bit having the first logic value among residual bits of the dividend AI from which the effective dividend NU is extracted. The preprocessor may determine the overflow OF bit as the first logic value, corresponding to that the correction bit is detected. The preprocessor may determine the overflow OF bit as the second logic value, corresponding to that the correction bit is not detected.

The calculator may output a division value QU as a result obtained by performing a comparison calculation operation once more than the maximum bit number of the division maximum value MI, based on the effective divisor DE and the effective dividend NU. The division value QU may be y+1 bits through the comparison calculation operation performed once more than the maximum bit number of the division maximum value MI.

The postprocessor may correct the division value QU, based on the overflow OF bit. The postprocessor may output the output signal YO expressed as y bits by correcting the division value QU.

The postprocessor may change the division value QU to a maximum value determined based on the division maximum value MI, corresponding to that the overflow OF bit is the first logic value. In an embodiment of the present disclosure, the maximum value may be 2^{y}−1. Even when the overflow OF bit is the second logic value, the postprocessor may change the division value QU to the maximum value determined based on the division maximum value MI, corresponding to that the division value QU is greater than or equal to the division maximum value MI.

In an embodiment of the present disclosure, the calculator may perform a round-off operation on the division value QU, based on a remainder of the comparison calculation operation performed finally. When the round-off operation is performed, an error between a final calculation result in accordance with the embodiment of the present disclosure and a calculation result using the dividend AI and the divisor BI can be decreased. The calculator may increase the division value QU by 1, corresponding to that a multiple of 2 of the remainder of the comparison calculation operation is greater than or equal to the effective divisor DE.

In an embodiment of the present disclosure, the preprocessor may change the effective divisor DE, the effective dividend NU, and the overflow OF bit to predetermined fixed values, corresponding to that all bit values of the divisor BI are 0. The calculator may calculate the division value QU according to the effective divisor DE, the effective dividend NU, and the overflow OF bit, which are changed to the fixed values. The predetermined fixed values may be values adjusted such that a maximum value of the output signal YO is output.

In another embodiment of the present disclosure, the preprocessor may change the dividend AI and the divisor BI to predetermined fixed values, corresponding to that all the bit values of the divisor BI are 0. The dividend AI and the divisor BI, which are changed to fixed values, may be values adjusted such that the maximum value of the output signal YO is output.

In still another embodiment of the present disclosure, the calculation processing device may output, as a final output, information on the divisor BI and the maximum value determined based on the division maximum value MI. The preprocessor may omit the operations of the calculator and the postprocessor and output the output signal YO. An additional circuit may be required such that the output signal YO is output through a preprocessing operation.

The preprocessor may output, as the final output, the information on the divisor BI and the maximum value determined based on the division maximum value MI, corresponding to that the overflow OF bit is the first logic value. The preprocessor may omit the operations of the calculator and the postprocessor and output the output signal YO.

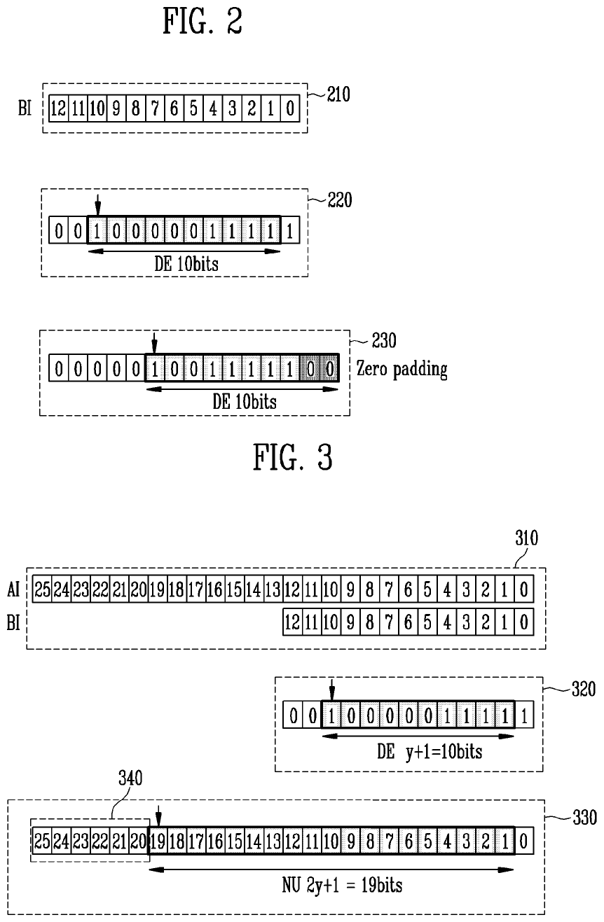

FIG. 2 is a diagram illustrating a method of generating the effective divisor in accordance with an embodiment of the present disclosure.

Referring to FIG. 2, the effective divisor DE may be extracted from the divisor BI, based on a maximum bit number of the division maximum value MI. For convenience of description, it may be assumed that the divisor BI is 13 bits (210) and the maximum bit number of the division maximum value MI is 9 bits or y=9.

It can be seen from FIG. 2 that a bit number of the effective divisor DE is 10 bits, based on the maximum bit number of the division maximum value MI and the divisor BI. The preprocessor may detect, as a first position, a position of a most significant bit having the first logic value among bits of the divisor BI. In FIG. 2, the first position may be position (220). The preprocessor may generate the effective divisor DE including bits from bit 10 to bit 1.

When the first position is position 7 (230), a number of bits from bit 7 to bit 0 is smaller than the maximum bit number of the division maximum value MI+1. The preprocessor may perform a zero padding on an insufficient portion of the effective divisor DE, thereby filling the insufficient portion of the effective divisor DE with a value of 0. In FIG. 2, bits extracted from the effective divisor DE are shadowed. Bits added through the zero padding may be darkly shadowed. The zero padding may be performed on a least significant bit side of the effective divisor DE according to the first position.

FIG. 3 is a diagram illustrating a method of generating the effective divisor, the effective dividend, and the overflow bit in accordance with an embodiment of the present disclosure.

Referring to FIG. 3, it may be assumed that the dividend AI is 26 bits, the divisor BI is 13 bits, and the maximum bit number of the division maximum value is 9 bits, or y=9 (310).

Like FIG. 2, the preprocessor may detect a first position as a position of a most significant bit having the first logic value in the divisor BI and a second position as a position of a least significant bit of the effective divisor DE (320). Since the effective divisor DE is 10 bits, the first position may be bit 10, and the second position may be bit 1.

The preprocessor may generate an effective dividend NU including bits corresponding to 19 bits from position 2 of the dividend AI (330). The effective dividend NU may include bits from bit 19 to bit 1 of the dividend AI. Since the bit number of the dividend AI is sufficiently large, the zero padding might not be performed.

The preprocessor may detect whether any bit including the first logic value is included in residual bits (340) of the dividend AI from which the effective dividend NU is extracted. In FIG. 3, bits from bit 25 to bit 20 may correspond to the residual bits. When bits having the first logic value exist in the residual bits, a calculation result of the dividend AI and the divisor BI exceeds 9 bits as the maximum bit number of the division maximum value. The preprocessor may determine the overflow OF bit as the first logic value, corresponding to that the bits having the first logic value exist in the residual bits.

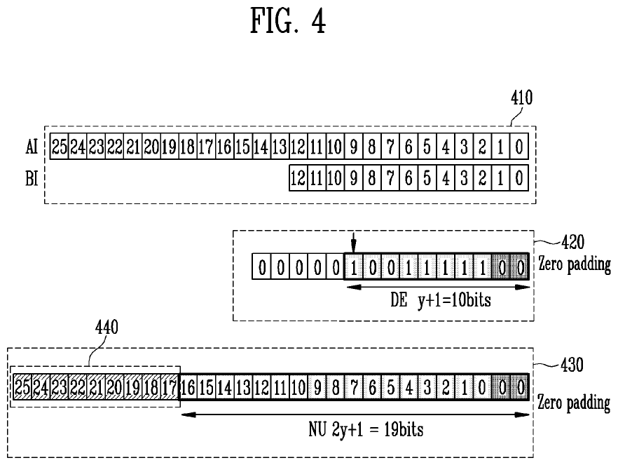

FIG. 4 is a diagram illustrating a method of generating the effective divisor, the effective dividend, and the overflow bit in accordance with another embodiment of the present disclosure.

Referring to FIG. 4, like FIG. 3, it may be assumed that the dividend AI is 26 bits, the divisor BI is 13 bits, and the maximum bit number of the division maximum value is 9 bits, or y=9 (410). A most significant bit having the first logic value among the bits included in the divisor BI may have number 7 (420). Since the number of the most significant bit is smaller than 9 bits as the maximum bit number of the division maximum value, the zero padding may be performed on a least significant bit of the effective divisor DE.

The zero padding may be performed on a least significant bit of the effective dividend NU, corresponding to that the zero padding is performed on the effective divisor DE (430). Numbers of bits having a value of 0, which are added to the effective divisor DE and the effective dividend NU, are the same.

The preprocessor may generate an effective dividend NU which includes bits from bit 16 to bit 0 and has two zero bits added thereto. In FIG. 4, bits on which the zero padding is performed may be darkly shadowed.

Like FIG. 3, the preprocessor may detect whether any bit having the first logic value is included in residual bits (440) of the dividend AI from which the effective dividend NU is extracted. The preprocessor may determine the overflow OF bit as the second logic value, corresponding to that any bits having the first logic value are not detected between bits from bit 25 to bit 17 of the dividend AI. In FIG. 4, the residual bits may be displayed as slashed areas. When any bits having the first logic value are not detected in the residual bits, a division value as a division result of the effective divisor DE and the effective divisor NU may be equal to a division result of the dividend AI and the divisor BI. The division value may be output as an output signal without any additional correction.

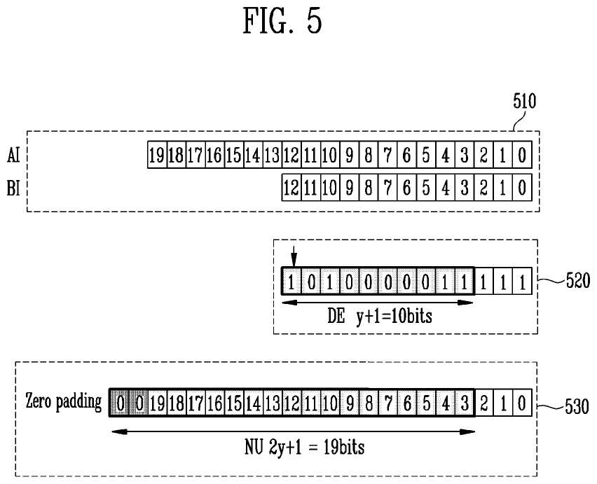

FIG. 5 is a diagram illustrating a method of generating the effective divisor, the effective dividend, and the overflow bit in accordance with still another embodiment of the present disclosure.

Referring to FIG. 5, it may be assumed that the dividend AI is 20 bits, the divisor BI is 13 bits, and the maximum bit number of the division maximum value is 9 bits (510). A most significant bit having the first logic value among the bits included in the divisor BI may have number 12 (520). Like FIG. 3, the preprocessor may generate the effective divisor DE.

A sum of the number of the most significant bit having the first logic value in the divisor BI and the maximum bit number of the division maximum value may be greater than a bit number of the dividend AI. The preprocessor may add bits having a value of 0, which corresponds to a number of insufficient bits to the most significant bit of the effective dividend NU. In FIG. 5, bits on which the zero padding is performed may be darkly shadowed (530).

The preprocessor may determine the overflow OF bit as the second logic value, corresponding to that the zero padding is performed on the most significant bit of the effective dividend NU. Since residual bits of the dividend AI from which the effective dividend NU is extracted do not exist, the preprocessor may generate the overflow OF bit without detection of any additional bit.

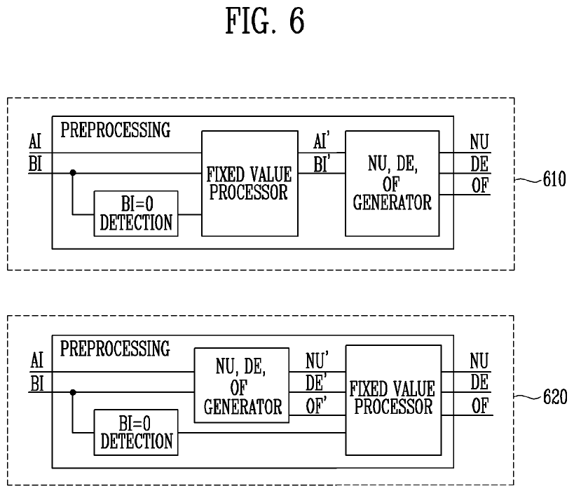

FIG. 6 is a diagram illustrating a fixed value generated according to a value of a divisor in accordance with an embodiment of the present disclosure.

Referring to FIG. 6, the preprocessor may change the effective divisor DE and the effective dividend NU to fixed values according to a value of the divisor BI. When the divisor BI is 0, the division value becomes an infinite value. Therefore, the division value exceeds the division maximum value.

When the division value exceeds the division maximum value, the preprocessor may change the dividend AI and the divisor BI to fixed values, and generate an effective divisor DE, an effective dividend NU, and an overflow OF bit, based on the changed fixed values (610). The division value calculated based on the generated effective divisor DE, the generated effective dividend NU, and the generated overflow OF bit may be a maximum value determined based on the division maximum value.

In another embodiment of the present disclosure, the preprocessor may change the effective divisor DE, the effective dividend NU, and the overflow OF bit, which have already been generated, to predetermined fixed values, corresponding to that all bits included in the divisor BI have the second logic value (620). The division value calculated based on the changed effective divisor DE, the changed effective dividend NU, and the changed overflow OF bit may be a maximum value determined based on the division maximum value. An output signal may be equally the maximum value even when the value of the divisor BI is 0, regardless of the order in which the preprocessor generates the fixed values.

In another embodiment of the present disclosure, the preprocessor may omit the comparison calculation operation and the postprocessing operation, corresponding to that the value of the divisor BI is 0, and output, as the output signal, the maximum value determined based on the division maximum value. An additional circuit may be required such that the output signal is output through only the preprocessing operation.

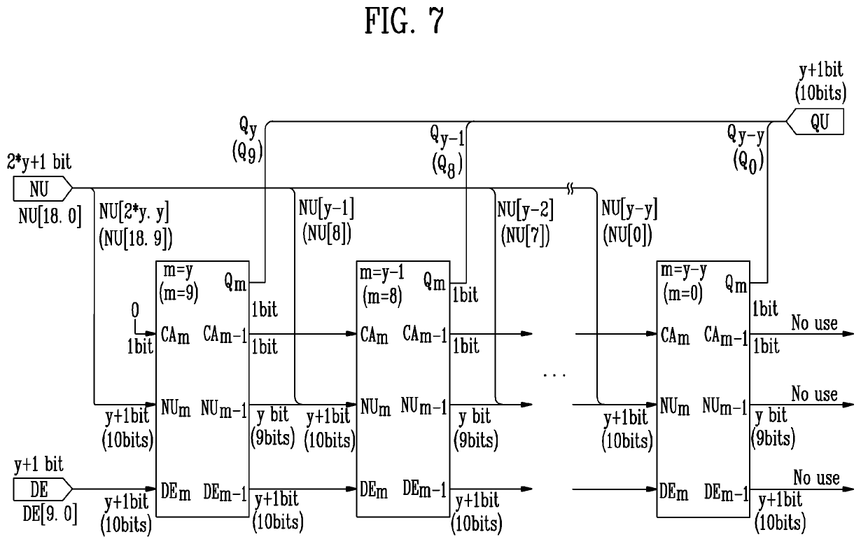

FIG. 7 is a diagram illustrating a method of calculating a division value by performing the comparison calculation operation in accordance with an embodiment of the present disclosure.

Referring to FIG. 7, the calculator may perform the comparison calculation operation once more than the maximum bit number y of the division maximum value. For convenience of description, the maximum bit number y of the division maximum value may be assumed as 9.

The effective divisor DE and the effective dividend NU may be input to the calculator. A comparison calculator included in the calculator may add a result CAₘ of a previous comparison calculation operation to an upper bit of the effective dividend NU. When an initial comparison calculation operation is performed, the result CAₘ may be a value of 0. The comparison calculator may receive the effective divisor DE and the effective dividend NU, and output an effective divisor DE, an effective dividend NU, result CAₘ, and a division value QU of a next comparison calculation operation.

The calculator may perform the comparison calculation operation by a number of (y+1) times. In FIG. 7, the calculator may perform the comparison calculation operation a total of ten times. The calculator may include ten comparison calculators. A comparison calculator is indicated by a box in FIG. 7. In an embodiment of the present disclosure, when any round-off operation is not performed, the remainder of the comparison calculation operation might not be used.

In another embodiment of the present disclosure, the calculator may perform a final comparison calculation operation and then perform a round-off operation on the division value QU, based on the remainder of the comparison calculation operation. The calculator may increase the division value QU by 1, corresponding to that a multiple of 2 of the remainder of the comparison calculation operation is greater than or equal to the effective divisor DE. The calculator may output the division value QU as it is, corresponding to that the multiple of 2 of the remainder of the comparison calculation operation is smaller than the effective divisor DE. The calculator may increase the division value QU by two times by shifting the remainder of the comparison calculation operation to the left by 1 bit. It may be assumed that numbers shown in FIG. 7 are binary numbers.

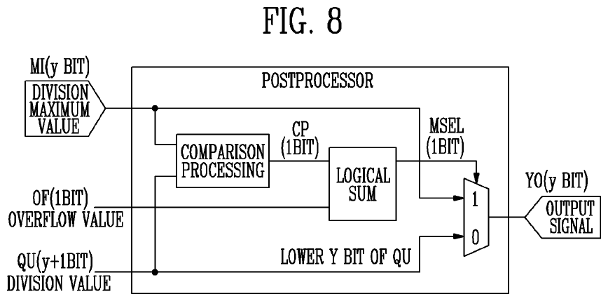

FIG. 8 is a diagram illustrating a method of correcting a division value, based on an overflow bit in accordance with an embodiment of the present disclosure.

Referring to FIG. 8, the postprocessor may output an output signal YO by receiving a division maximum value MI, an overflow OF bit, and a division value QU. For convenience of description, it may be assumed that a maximum bit number of the division maximum value MI is y bits, the overflow OF bit is 1 bit, and the division value QU is y+1 bits.

The postprocessor may perform a comparison operation of the division maximum value MI and the division value QU. The postprocessor may output the first logic value as an intermediate result CP value, corresponding to that the division value QU is greater than or equal to the division maximum value MI. The postprocessor may output the second logic value as the intermediate result CP value, corresponding to that the division value QU is smaller than the division maximum value MI.

The postprocessor may instruct whether the output signal is to be corrected, based on the intermediate result CP value and the overflow OF bit. The postprocessor may output a select signal for maintaining the division value QU, corresponding to that both the intermediate result CP value and the overflow OF bit correspond to the first logic value. The postprocessor may output a select signal for changing the division value QU to 2^{y}−1, corresponding to that both the intermediate result CP value and the overflow OF bit correspond to the second logic value or different logic values.

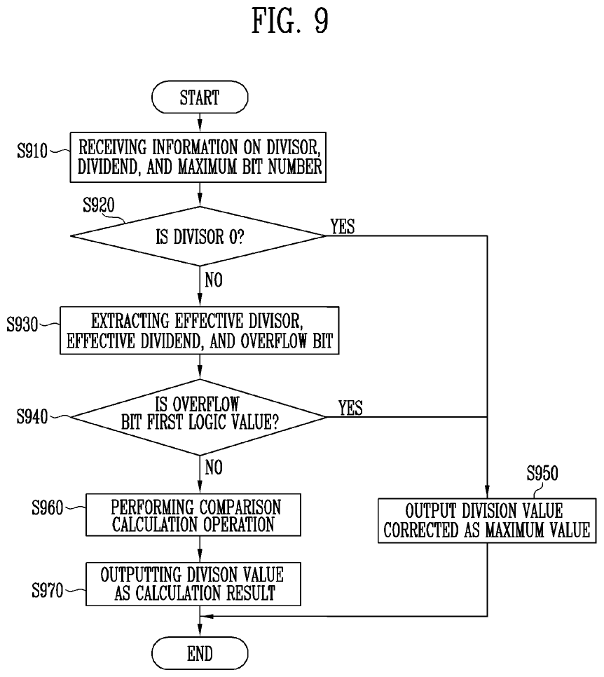

FIG. 9 is a flowchart illustrating a calculation processing method in which a maximum bit number of an output signal is determined in accordance with an embodiment of the present disclosure.

Referring to FIG. 9, in an embodiment, the calculation processing device may decrease a calculation amount according to a maximum bit number of an output signal, and improve a calculation speed. In an embodiment of the present disclosure, the image processing device may perform a calculation operation in which the maximum bit number of the output signal is limited to y, based on pixel values received from the outside. The image processing device may include a calculation processing device including a preprocessor for extracting an effective divisor, an effective dividend, and an overflow bit for correcting a calculation result from a divisor and a dividend, based on the maximum bit number y, a calculator for outputting a division value obtained by performing a comparison calculation operation y+1 times, based on the effective divisor and the effective dividend, and a postprocessor for correcting the division value, based on the overflow bit.

In step S910, information on the divisor, the dividend, and the maximum bit number y of the output signal may be received by the calculation processing device. A calculation amount may be decreased according to the maximum bit number of the output signal. The calculation amount may be the amount of steps needed to perform a calculation or a time needed or both. Corresponding to the decrease in calculation amount, a processing speed can be increased, and the performance of the device can be improved for an embodiment. In another embodiment of the present disclosure, the maximum bit number y may be pre-stored in the calculation processing device.

In step S920, the preprocessor may determine whether the divisor is 0. When the divisor is 0, the preprocessor does not perform any additional operation, but may output, as an output signal, a maximum value of 2^{y}−1, which is determined according to the maximum bit number (S950). When the divisor is not 0, the preprocessor may extract an effective divisor, an effective dividend, and an overflow bit, which are used to decrease the calculation amount (S930). The step S920 may correspond to the descriptions of FIG. 6.

In the step S930, the preprocessor may extract an effective divisor, an effective dividend, and an overflow bit for correcting a calculation result from the divisor and the dividend, based on the maximum bit number y. The preprocessor may detect a first position as a position of a most significant bit having a first logic value in the divisor. The preprocessor may generate an effective divisor including (y+1) bits in a lower bit direction from the first position.

The preprocessor may detect a second position as a position of the dividend, which corresponds to a position of a least significant bit of the effective divisor. The preprocessor may generate an effective dividend including (2y+1) bits in an upper bit direction from the second position. The preprocessor may determine the overflow bit as the first logic value, corresponding to that a bit having the first logic value among residual bits of the dividend from which the effective dividend is extracted is detected.

The step S930 may correspond to the descriptions of FIGS. 1 to 5.

In step S940, the preprocessor may determine whether the overflow bit is the first logic value. The preprocessor may proceed to the step S950, corresponding to that the overflow bit is the first logic value. The preprocessor does not perform any division operation on the effective divisor and the effective dividend, but may output, as the output signal, the maximum value of 2^{y}−1, which is determined according to the maximum bit number (S950).

When the residual bits of the dividend from which the effective dividend is extracted all have a second logic value, the overflow bit may be the second logic value. The preprocessor may perform a division operation, corresponding to that the overflow bit is the second logic value (S960).

In the step S960, the calculator may generate a division value obtained by performing the comparison calculation operation (y+1) times, based on the effective divisor and the effective dividend. The calculator may perform the comparison calculation operation by using a non-restoring method.

In step S970, the calculator may output a division value generated by performing the calculation operation. The postprocessor may correct the division value, based on the overflow bit before the generated division value is output.

The steps S940, S950, S960, and S970 may correspond to the descriptions of FIGS. 1 and 8.

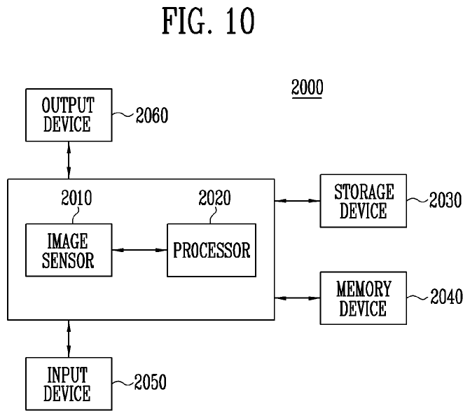

FIG. 10 is a diagram illustrating an electronic device including a calculation processing device in accordance with an embodiment of the present disclosure.

Referring to FIG. 10, the electronic device 2000 may include an image sensor 2010, a processor 2020, a storage device 2030, a memory device 2040, an input device 2050, and an output device 2060. Although not shown in FIG. 10, the electronic device 2000 may further include ports capable of communicating with a video card, a sound card, a memory card, a USB device, and the like, or communicating with other electronic devices.

The image sensor 2010 may generate image data corresponding to incident light. The image data may be transferred to the processor 2020 to be processed. The image sensor 2010 may generate image data about an object input (or captured) through a lens. The lens may include at least one lens forming an optical system.

The image sensor 2010 may include a plurality of pixels. The image sensor 2010 may generate, in the plurality of pixels, a plurality of pixel values corresponding to a photographed image. The plurality of pixel values generated in the image sensor 2010 may be transmitted as pixel data to the processor 2020. That is, the image sensor 2010 may generate a plurality of pixel values corresponding to a single frame.

The processor 2020 may be an image processing device which performs a calculation of processing image data received from the image sensor 2010 and outputs the processed image data. The processor 2020 may include a data receiver receiving pixel values from an external device. The processing may be Electronic Image Stabilization (EIS), interpolation, color tone correction, image quality correction, size adjustment, or the like.

In an embodiment of the present disclosure, the processor 2020 may perform a division operation on the received pixel data. In an embodiment, the processor 2020 may perform a division operation in which a bit number of an output signal is limited to improve a processing speed of the division operation. The processor 2020 may extract an effective divisor, an effective dividend, and an overflow bit for result correction from a divisor and a dividend, which are included in the pixel data, based on a maximum bit number of the output signal, and correct a result of a comparison calculation operation performed (the maximum bit number+1) times, based on the overflow bit.

The processor 2020 may be implemented as a chip independent from the image sensor 2010. For example, the processor 2020 may be implemented with a multi-chip package. In another embodiment of the present disclosure, the processor 2020 may be included as a portion of the image sensor 2010 to be implemented as one chip.

The processor 2020 may execute and control an operation of the electronic device 2000. In accordance with an embodiment of the present disclosure, the processor 2020 may be a microprocessor, a Central Processing Unit (CPU), or an Application Processor (AP). The processor 2020 may be connected to the storage device 2030, the memory device 2040, the input device 2050, and the output device 2060 through an address bus, a control bus, and a data bus, to perform communication.

The storage device 2030 may include a flash memory device, a Solid State Drive (SSD), a Hard Disk Drive (HDD), a CD-ROM, all types of nonvolatile memory devices, and the like.

The memory device 2040 may store data necessary for an operation of the electronic device 2000. For example, the memory device 2040 may include a volatile memory device such as a Dynamic Random Access Memory (DRAM) or a Static Random Access Memory (SRAM) and a nonvolatile memory device such as an Erasable Programmable Read-Only Memory (EPROM), an Electrically Erasable Programmable Read-Only Memory (EEPROM), or a flash memory device. The processor 2020 may control the image sensor 2010 and the output device 2060 by executing a command set stored in the memory device 2040.

The input device 2050 may include an input means such as a keyboard, a keypad, or a mouse, and the output device 2060 may include an output means such as a printer or a display.

The image sensor 2010 may be implemented with various types of packages. For example, components of at least a portion of the image sensor 2010 may be implemented by using packages such as Package-on-Package (PoP), Ball Grid Arrays (BGAs), Chip Scale Packages (CSPs), Plastic Leaded Chip Carrier (PLCC), Plastic Dual In-line Package (PDIP), Die in Waffle Pack, Die in Wafer Form, Chip-On-Board (COB), CERamic Dual In-line Package (CERDIP), Plastic Metric Quad Flat Pack (MQFP), Thin Quad Flat Pack (TQFP), Small Outline (SOIC), Shrink Small Outline Package (SSOP), Thin Small Outline (TSOP), System In Package (SIP), Multi-Chip Package (MCP), Wafer-level Fabricated Package (WFP), Wafer-level Processed Stack Package (WSP), and Wafer-level Processed Package (WSP).

Meanwhile, the electronic device 2000 may be interpreted as all computing systems using the image sensor 2010. The electronic device 2000 may be implemented in the form of a packaged module, a component, or the like. For example, the electronic device 2000 may be implemented as a digital camera, a mobile device, a smart phone, a Personal Computer (PC), a tablet PC, a notebook computer, a Personal Digital Assistant (PDA), an Enterprise Digital Assistant (EDA), a Portable Multimedia Player (PMP), a wearable device, a black box, a robot, an autonomous vehicle, or the like.

In accordance with an embodiment of the present disclosure, there can be provided an image processing device and a calculating method thereof, in which a comparison calculation operation for generating an output signal is performed by only a number corresponding to a maximum bit number of the output signal, thereby decreasing the calculation amount of the image processing device.

While the present disclosure has been shown and described with reference to certain embodiments thereof, it will be understood by those skilled in the art that various changes in form and details may be made therein without departing from the spirit and scope of the present disclosure as defined by the appended claims and their equivalents. Therefore, the scope of the present disclosure should not be limited to the above-described embodiments but should be determined by not only the appended claims but also the equivalents thereof.

In the above-described embodiments, all steps may be selectively performed or part of the steps and may be omitted. In each embodiment, the steps are not necessarily performed in accordance with the described order and may be rearranged. The embodiments disclosed in this specification and drawings are only examples to facilitate an understanding of the present disclosure, and the present disclosure is not limited thereto. That is, it should be apparent to those skilled in the art that various modifications can be made on the basis of the technological scope of the present disclosure.

Meanwhile, the embodiments of the present disclosure have been described in the drawings and specification. Although specific terminologies are used here, those are only to explain the embodiments of the present disclosure. Therefore, the present disclosure is not restricted to the above-described embodiments and many variations are possible within the spirit and scope of the present disclosure. It should be apparent to those skilled in the art that various modifications can be made on the basis of the technological scope of the present disclosure in addition to the embodiments disclosed herein.

What is claimed is:

1. A calculation processing device comprising:
a preprocessor configured to extract an effective divisor, an effective dividend, and an overflow bit for correcting a division value from a divisor and a dividend, based on a maximum bit number of the division value;
a calculator configured to output the division value as a result obtained by performing a comparison calculation operation by a number of times, which is determined according to the maximum bit number, based on the effective divisor and the effective dividend; and
a postprocessor configured to correct the division value, based on the overflow bit.

2. The calculation processing device of claim 1, wherein the calculator performs the comparison calculation operation (the maximum bit number+1) times, and
wherein the preprocessor detects a first position as a position of a most significant bit having a first logic value in the divisor, and generates the effective divisor including (the maximum bit number+1) bits in a lower bit direction from the first position.

3. The calculation processing device of claim 2, wherein the preprocessor performs first padding of filling a residual portion of the effective divisor with a second logic value, corresponding to that a number of remaining bits in the lower bit direction from the first position of the divisor is smaller than the maximum bit+1.

4. The calculation processing device of claim 3, wherein the preprocessor detects a second position as a position of the dividend, which corresponds to a position of a least significant bit of the effective divisor, and generates the effective dividend including (the maximum bit+1) bits in an upper bit direction from the second position.

5. The calculation processing device of claim 4, wherein the preprocessor performs second padding of filling lower bits of the effective dividend with the second logic value by the same number as the first padding.

6. The calculation processing device of claim 5, wherein the preprocessor detects a correction bit having the first logic value among residual bits of the dividend from which the effective dividend is extracted, and determines the overflow bit as the first logic value, when the correction bit is detected.

7. The calculation processing device of claim 6, wherein the preprocessor determines the overflow bit as the second logic value, when the correction bit is not detected.

8. The calculation processing device of claim 7, wherein the postprocessor changes the division value to a maximum value determined based on the maximum bit number, when the overflow bit is the first logic value.

9. The calculation processing device of claim 8, wherein the calculator performs a round-off operation on the division value, based on a remainder of the comparison calculation operation performed finally.

10. The calculation processing device of claim 9, wherein the calculator increases the division value by 1, when a multiple of 2 of the remainder of the comparison calculation operation is greater than or equal to the effective divisor.

11. The calculation processing device of claim 3, wherein the preprocessor changes the effective divisor, the effective dividend, and the overflow bit to predetermined fixed values, when all bit values of the divisor are the second logic value.

12. The calculation processing device of claim 3, wherein the preprocessor changes the divisor and the dividend to predetermined fixed values, when all bit values of the divisor are the second logic value, and generates the effective divisor, the effective dividend, and the overflow bit, based on the fixed values.

13. The calculation processing device of claim 3, wherein the preprocessor outputs, as a final output, information on the divisor and a maximum value determined based on the maximum bit number, when all bit values of the divisor are the second logic value.

14. The calculation processing device of claim 8, wherein the preprocessor outputs, as a final output, the overflow bit and the maximum value, when the correction bit is detected.

15. An image processing device comprising:
a data receiver configured to receive pixel values from an external device; and
a calculation processing device configured to perform a calculation operation with a maximum bit number of an output being limited to y, based on the pixel values,
wherein the calculation processing device includes:
a preprocessor configured to extract an effective divisor, an effective dividend, and an overflow bit for correcting the output from a divisor and a dividend, based on the maximum bit number;
a calculator configured to output a division value obtained by performing a comparison calculation operation (y+1) times, based on the effective divisor and the effective dividend; and
a postprocessor configured to correct the division value, based on the overflow bit,
wherein y is a natural number greater than zero.

16. The image processing device of claim 15, wherein the preprocessor generates the effective divisor including bits from bit k as a most significant bit having a value of 1 to bit k−y in the divisor, and generates the effective dividend including bits from bit k+y to bit k−y of the dividend.

17. The image processing device of claim 16, wherein the preprocessor performs a zero padding operation of filling bits of which bit numbers are negative numbers in the effective divisor and the effective dividend with a value of 0, when the k is greater than the y.

18. The image processing device of claim 17, wherein the preprocessor generates the overflow bit having a predetermined logic value, when a bit having a value of 1 among residual bits of the dividend from which the effective dividend is extracted is detected.

19. The image processing device of claim 18, wherein the postprocessor changes the division value to 2^{y}−1, when the overflow bit is the logic value.

20. A calculation processing method comprising:
receiving information on a divisor, a dividend, and a maximum bit number y of a division value;
extracting an effective divisor, an effective dividend, and an overflow bit for correcting the division value from the divisor and the dividend, based on the maximum bit number y;
generating the division value obtained by performing a comparison calculation operation (y+1) times, based on the effective divisor and the effective dividend; and
correcting the division value, based on the overflow bit,
wherein y is a natural number greater than zero.

21. The calculation processing method of claim 20, wherein the extracting of the effective divisor, the effective dividend, and the overflow bit includes:
detecting a first position as a position of a most significant bit having a first logic value in the divisor;
generating the effective divisor including (y+1) bits in a lower bit direction from the first position;
detecting a second position as a position of the dividend, which corresponds to a position of a least significant bit of the effective divisor;
generating the effective dividend including (2y+1) bits in an upper bit direction from the second position; and
determining the overflow bit as the first logic value, when a bit having the first logic value among residual bits of the dividend from which the effective dividend is extracted is detected.

22. The calculation processing method of claim 21, wherein the correcting of the division value includes:
changing 2^{y}−1 to the division value, when the overflow bit is the first logic value; and
outputting the 2^{y}−1.
